(19) United States
(12) Patent Application Publication
(10) Pub. No.: US 2024/0014431 A1
(43) Pub. Date: Jan. 11, 2024

(54) FUEL CELL AND MANUFACTURING METHOD THEREOF

(71) Applicants: Hyundai Motor Company, Seoul (KR); Kia Corporation, Seoul (KR); Dong Yang Piston Co., Ltd., Ansan (KR)

(72) Inventors: Jae Min Ahn, Yongin (KR); Yong Suk Heo, Seoul (KR); Dong Jin Son, Ansan (KR); Yong Woo Choi, Ansan (KR)

(21) Appl. No.: 18/128,374

(22) Filed: Mar. 30, 2023

(30) Foreign Application Priority Data
Jul. 11, 2022 (KR) 10-2022-0085116

(51) Int. Cl. H01M 8/2485; H01M 8/0284

(52) U.S. Cl. CPC H01M 8/2485; H01M 8/0284; H01M 2250/20

(57) ABSTRACT

A fuel cell of the present disclosure includes a cell stack including a plurality of unit cells stacked in a first direction, an end plate disposed on each of two ends of the cell stack and including a metal portion subjected to molecular adhesion surface treatment and a resin portion disposed on at least a portion of the surface of the metal portion, an enclosure coupled to the end plate to envelop the cell stack, and an outer gasket disposed between the enclosure and the end plate and being in contact with the metal portion of the end plate.

This application claims under 35 U.S.C. § 119(a) the benefit of Korean Patent Application No. 10-2022-0085116, filed on Jul. 11, 2022, which is hereby incorporated by reference as if fully set forth herein.

### BACKGROUND

### Technical Field

Embodiments of the present disclosure relate to a fuel cell and a manufacturing method thereof.

### Background

A fuel cell system is a system that generates electricity through an oxidation reaction of hydrogen, which is a reactant gas, and a reduction reaction of oxygen, which is a reactant gas, using a polymer electrolyte membrane. To this end, a fuel cell includes a cell stack, in which a plurality of cells are stacked, and an end plate, which is disposed on each of both ends of the cell stack to maintain force for clamping the cells together with an enclosure. Alternatively, an enclosure, which envelops upper and lower stack modules, may be coupled to a manifold block, which is provided with reactant gas and coolant supply passages, and to a side cover to embody a fuel cell.

In this case, because a metal insert and a resin portion (that is, plastic) of the end plate, the manifold block, or the side cover have mutually different coefficients of thermal expansion, various problems may occur as follows.

First, the following problem may arise in the manufacturing process. In detail, during an insert injection molding process, when an injection-molded product is ejected from a mold after the resin portion is applied onto the metal insert, the high-temperature plastic contracts, and thus separation occurs at the interface between the metal insert and the resin portion, leading to formation of a raised portion. Consequently, the flatness of the injection-molded product is poor.

In addition, even if the injection-molded product is manufactured such that the initial flatness requirements thereof are met by strictly controlling the injection molding conditions and forming a structural undercut, a lifting phenomenon occurs between the metal insert and the resin portion, or the resin portion cracks because the injection-molded product is vulnerable to thermal shock caused by the vehicle driving conditions or environment. Therefore, the airtightness performance and the insulation performance of the stack may be deteriorated, and thus the durability thereof may be deteriorated.

In addition, the reactant gas communication portion and the coolant communication portion in the end plate are covered by the resin portion, which is made of a plastic material, in order to ensure insulation performance. In this case, moisture may enter the gap between the metal insert and the resin portion. Therefore, the resin portion of the end plate needs to extend to an outer gasket, which is disposed between the enclosure and the end plate, in order to ensure the watertight structure of the stack. However, this structure is still problematic in that watertightness and airtightness are not ensured.

### SUMMARY

Accordingly, embodiments are directed to a fuel cell and a manufacturing method thereof that substantially obviate one or more problems due to limitations and disadvantages of the related art.

Embodiments provide a fuel cell including a metal portion and a resin portion, which are reliably bonded to each other, and a manufacturing method thereof.

However, objects to be accomplished by the embodiments are not limited to the above-mentioned objects, and other objects not mentioned herein will be clearly understood by those skilled in the art from the following description.

In one aspect, a fuel cell is provided comprising: (a) a cell stack comprising a plurality of unit cells stacked in a first direction; and (b) an end plate disposed on each of two ends of the cell stack, the end plate comprising i) a metal portion and ii) a resin portion disposed on at least a portion of a surface of the metal portion; (c) an enclosure coupled to the end plate. In certain aspects, the fuel cell suitably further comprises a gasket disposed between the enclosure and the end plate and being in contact with the metal portion of the end plate. In certain aspects, the end plate metal portion has a surface topography to facilitate adhesion of the resin portion.

In certain aspects, an end plate disposed on an end plate of a cell stack may have a metal portion that is textured or has some topography (including micro-topography) that can enhance adhesion to the metal portion of an applied resin or other applied material. For example, an end plate metal portion may be etched (e.g. chemically or mechanically etched) to produce a micro-topography pitted surface. A mechanical etching can be for example rubbing with an abrasive material. In certain aspects herein, references to a molecular adhesion surface treatment suitably include a condition of the end plate metal portion that can enhance adhesion to the metal portion enhance adhesion of an applied resin or other applied material, such as a mechanical or chemical etching, or other treatment such as applying an organic or inorganic adhesion later.

In a certain aspect a fuel cell is provided that suitably may include a cell stack including a plurality of unit cells stacked in a first direction, an end plate disposed on each of two ends of the cell stack and including a metal portion subjected to molecular adhesion surface treatment and a resin portion disposed on at least a portion of the surface of the metal portion, an enclosure coupled to the end plate to envelop the cell stack, and an outer gasket disposed between the enclosure and the end plate and being in contact with the metal portion of the end plate.

In an example, the end plate may include an inner surface facing the cell stack, an outer surface located opposite the inner surface in the first direction, a fluid inlet receiving a fluid to be supplied to the cell stack, and a fluid outlet discharging a fluid flowing out of the cell stack. The resin portion may include a first portion disposed in each of the fluid inlet and the fluid outlet, a second portion extending from the first portion to the inner surface, and a third portion extending from the first portion to the outer surface.

In an example, the second portion of the resin portion may be disposed so as to be spaced apart from a boundary between the inner surface of the end plate and the enclosure.

In an example, the metal portion may include a plurality of pores formed in the surface thereof, and the resin portion may be disposed on the surface of the metal portion while being embedded in the pores.

In an example, the plurality of pores may have respectively different sizes.

In an example, each of the plurality of pores may have a diameter of about 0.1 μm to about 20 μm.

In an example, the end plate may further include a coupling groove formed in the outer surface thereof, and the coupling groove may not overlap the resin portion in the first direction.

In an example, the fuel cell may further include an anodizing layer formed on the surface of the metal portion, and the anodizing layer may be disposed so as to cover an end portion of a boundary between the metal portion and the resin portion.

In an example, at least one of the metal portion or the resin portion may have a sectional shape chamfered or filleted at the end portion of the boundary.

In an example, the metal portion and the resin portion may have sectional shapes symmetrical with each other in a second direction at the end portion of the boundary, the second direction may intersect the first direction, and the metal portion and the resin portion may face each other in the second direction.

In an example, for the adhesion strength between the metal portion and the resin portion, tensile strength may be about 300 MPa or greater and the shear strength may be about 16 MPa or greater.

A method of manufacturing a fuel cell according to another embodiment may include preparing a metal insert, performing molecular adhesion surface treatment on the metal insert, and forming a resin on a metal portion, subjected to the molecular adhesion surface treatment, through injection molding to manufacture a resin portion.

In an example, the performing molecular adhesion surface treatment may include etching the metal insert using an etchant to form a pore in the surface of the metal insert. In a further embodiment, as discussed above, a molecular adhesion surface treatment can include a mechanical treatment of the metal portion, for example rubbing or other contacting of an abrasive material on the metal portion.

In an example, the performing molecular adhesion surface treatment may further include degreasing the metal insert before the etching and electrolytically treating the surface of the metal insert using an electrolyte after the etching to complete manufacture of the metal portion.

In an example, the etching may include forming a first pore in the surface of the metal insert using a first etchant and forming a second pore, which is smaller than the first pore, in the surface of the metal insert using a second etchant.

In an example, the method may further include anodizing the metal portion after performing the injection molding and washing a product obtained by the anodizing.

A fuel cell according to still another embodiment may include a plurality of stack modules, a manifold block disposed on one of two ends of each of the plurality of stack modules, a side cover disposed on the other of the two ends of each of the plurality of stack modules, an enclosure coupled to the manifold block and the side cover to envelop the plurality of stack modules, a first outer gasket disposed between one end portion of the enclosure and the manifold block, and a second outer gasket disposed between the other end portion of the enclosure and the side cover. The manifold block may include a first metal portion subjected to molecular adhesion surface treatment and a first resin portion disposed on at least a portion of the surface of the first metal portion. The side cover may include a second metal portion subjected to molecular adhesion surface treatment and a second resin portion disposed on at least a portion of the surface of the second metal portion. The first metal portion of the manifold block may be in contact with the first outer gasket, and the second metal portion of the side cover may be in contact with the second outer gasket.

In an example, each of the manifold block and the side cover may include an inner surface facing the plurality of stack modules, an outer surface located opposite the inner surface in the first direction, a fluid inlet receiving a fluid to be supplied to the plurality of stack modules, and a fluid outlet discharging a fluid flowing out of the plurality of stack modules. Each of the first resin portion and the second resin portion may include a fourth portion disposed in each of the fluid inlet and the fluid outlet, a fifth portion extending from the fourth portion to the inner surface, and a sixth portion extending from the fourth portion to the outer surface.

In an example, the fifth portion may be disposed so as to be spaced apart from a boundary between the inner surface and the enclosure.

As discussed, the method and system suitably include use of a controller or processer.

In another embodiment, vehicles are provided that comprise an apparatus or fuel cell as disclosed herein.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1A is a front perspective view of a fuel cell according to an exemplary embodiment;

FIG. 1B is a rear perspective view of the fuel cell according to the embodiment;

FIG. 2 is a cross-sectional view of the fuel cell according to the embodiment;

FIG. 3 is a cross-sectional view of the fuel cell according to the embodiment, taken along line I-I′ shown in FIG. 1A;

FIG. 4 is an enlarged cross-sectional view of portion A shown in FIG. 3;

FIG. 5 is an enlarged cross-sectional view of portion B shown in FIG. 3;

FIG. 6 is an enlarged cross-sectional view of portion K shown in FIG. 4;

FIG. 7A is a front perspective view of a fuel cell according to another embodiment;

FIG. 7B is a rear perspective view of the fuel cell according to the another embodiment;

FIG. 8 is a cross-sectional view of the fuel cell according to the another embodiment, taken along line II-II′ shown in FIG. 7A;

FIG. 9 is an enlarged cross-sectional view of portion C shown in FIG. 8;

FIG. 10 is a partial cross-sectional view of each of end plates, a manifold block, and a side cover in each of the fuel cells according to the embodiments;

FIGS. 11A to 11D show various embodiments of the metal portion and the resin portion shown in FIG. 10;

FIG. 12 is a flowchart for explaining a method of manufacturing a fuel cell according to an exemplary embodiment;

FIG. 13 is a flowchart for explaining an exemplary embodiment of step 420 shown in FIG. 12;

FIG. 14 is a partial cross-sectional view of a fuel cell according to a comparative example;

FIG. 15 is an enlarged cross-sectional view of portion D shown in FIG. 14;

FIG. 16 is an enlarged cross-sectional view of portion E shown in FIG. 14; and

FIG. 17 is a partial cross-sectional view of the fuel cell according to the comparative example.

### DETAILED DESCRIPTION

The present disclosure will now be described more fully hereinafter with reference to the accompanying drawings, in which various embodiments are shown. The examples, however, may be embodied in many different forms and should not be construed as being limited to the embodiments set forth herein. Rather, these embodiments are provided so that this disclosure will be more thorough and complete, and will more fully convey the scope of the disclosure to those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above” and “under/lower part/below”, are used only to distinguish between one subject or element and another subject or element, without necessarily requiring or involving any physical or logical relationship or sequence between the subjects or elements.

Hereinafter, fuel cells 100A and 100B and a manufacturing method 400 thereof according to embodiments will be described with reference to the accompanying drawings. The fuel cells 100A and 100B and the manufacturing method 400 thereof will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely. Hereinafter, for convenience of description, the +x-axis direction or the −x-axis direction will be referred to as a “first direction”, the +y-axis direction or the −y-axis direction will be referred to as a “second direction”, and the +z-axis direction or the −z-axis direction will be referred to as a “third direction”.

First, a fuel cell 100A according to an exemplary embodiment will be described below.

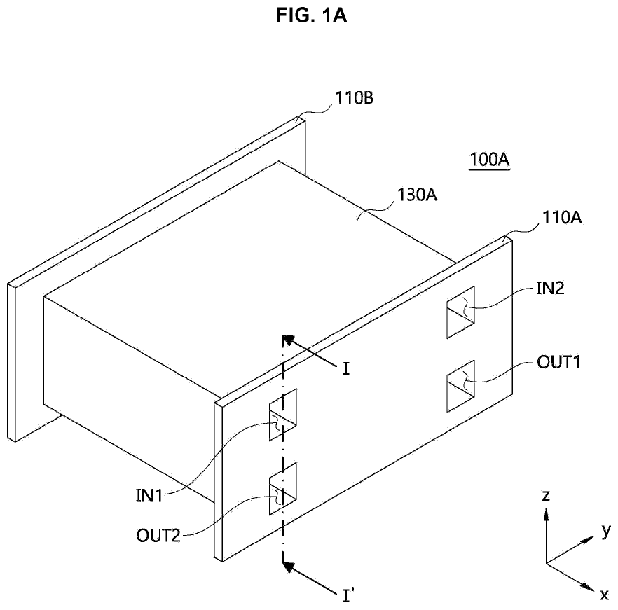

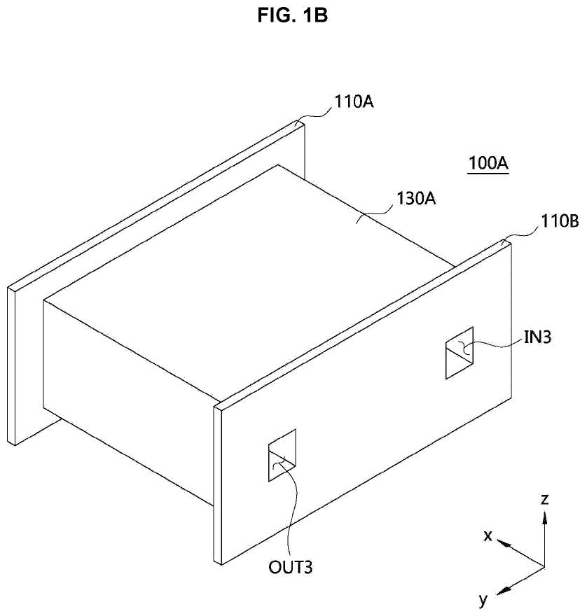

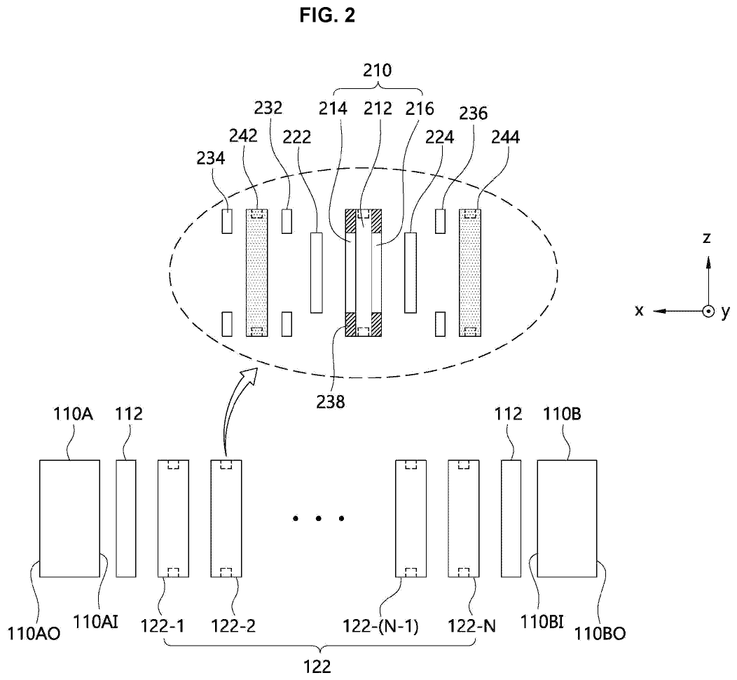

FIG. 1A is a front perspective view of the fuel cell 100A according to the embodiment, FIG. 1B is a rear perspective view of the fuel cell 100A according to the embodiment, and FIG. 2 is a cross-sectional view of the fuel cell 100A according to the embodiment. Illustration of the enclosure 130A shown in FIGS. 1A and 1B is omitted from FIG. 2.

The fuel cell 100A may be, for example, a polymer electrolyte membrane fuel cell (or a proton exchange membrane fuel cell) (PEMFC), which has been studied most extensively as a power source for driving vehicles. However, the embodiments are not limited to any specific form of the fuel cell 100A.

The fuel cell 100A may include end plates (or pressing plates or compression plates) 110A and 110B, a current collector 112, a cell stack (or a power generation module) 122, and an enclosure 130A.

The enclosure 130A shown in FIGS. 1A and 1B may be coupled to the end plates 110A and 110B, and may be disposed so as to surround at least part of the side portion of the cell stack 122 disposed between the end plates 110A and 110B. The enclosure 130A may serve to clamp a plurality of unit cells together with the end plates 110A and 110B in the first direction. In other words, the clamping pressure of the cell stack 122 may be maintained by the end plates 110A and 110B, which have rigid body structures, and the enclosure 130A.

The end plates 110A and 110B may be disposed on at least one of the two end portions of the cell stack 122, and may support and fix a plurality of unit cells. That is, the first end plate 110A may be disposed on one of the two end portions of the cell stack 122, and the second end plate 110B may be disposed on the other of the two end portions of the cell stack 122.

The fuel cell 100A may include a plurality of manifolds M. The plurality of manifolds may include fluid inflow portions, into which a fluid flows so as to be supplied to the cell stack 122, and fluid outflow portions, from which a fluid discharged from the cell stack 122 flows to the outside.

Specifically, the fluid inflow portions may include a first inflow communication portion (or a first inlet manifold) IN1, a second inflow communication portion (or a second inlet manifold) IN2, and a third inflow communication portion (or a third inlet manifold) IN3. The fluid outflow portions may include a first outflow communication portion (or a first outlet manifold) OUT1, a second outflow communication portion (or a second outlet manifold) OUT2, and a third outflow communication portion (or a third outlet manifold) OUT3.

One of the first and second inflow communication portions IN1 and IN2 may correspond to a hydrogen inlet through which hydrogen, which is a fluid supplied as a reactant gas from the outside, is introduced into the cell stack 122, and the other of the first and second inflow communication portions IN1 and IN2 may correspond to an oxygen inlet through which oxygen, which is a fluid supplied as a reactant gas from the outside, is introduced into the cell stack 122. In addition, one of the first and second outflow communication portions OUT1 and OUT2 may correspond to a hydrogen outlet through which hydrogen, which is a reactant gas, and condensed water are discharged as fluids out of the cell stack 122, and the other of the first and second outflow communication portions OUT1 and OUT2 may correspond to an oxygen outlet through which oxygen, which is a reactant gas, and condensed water are discharged as fluids out of the cell stack 122.

In an example, the first inflow communication portion IN1 may correspond to an oxygen inlet, the second inflow communication portion IN2 may correspond to a hydrogen inlet, the first outflow communication portion OUT1 may correspond to an oxygen outlet, and the second outflow communication portion OUT2 may correspond to a hydrogen outlet.

In addition, the third inflow communication portion IN3 may correspond to a coolant inlet into which a cooling medium (e.g. coolant) is introduced as a fluid from the outside, and the third outflow communication portion OUT3 may correspond to a coolant outlet through which a cooling medium is discharged as a fluid to the outside.

The first and second outflow communication portions OUT1 and OUT2 may be disposed below the first and second inflow communication portions IN1 and IN2, the first inflow communication portion IN1 and the first outflow communication portion OUT1 may be disposed at positions separated from each other in an oblique direction, and the second inflow communication portion IN2 and the second outflow communication portion OUT2 may be disposed at positions separated from each other in an oblique direction. Due to this arrangement of the first and second inflow communication portions IN1 and IN2 and the first and second outflow communication portions OUT1 and OUT2, condensed water may be discharged from the lower portions of the unit cells included in the cell stack 122, or may remain in the lower portions of the unit cells due to gravity.

According to the embodiment, the first and second inflow communication portions IN1 and IN2 and the first and second outflow communication portions OUT1 and OUT2 may be included in any one of the first and second end plates 110A and 110B (e.g. the first end plate 110A, as shown in FIG. 1A), and the third inflow communication portion IN3 and the third outflow communication portion OUT3 may be included in the other of the first and second end plates 110A and 110B (e.g. the second end plate 110B shown in FIG. 1B).

Referring to FIG. 2, the cell stack 122 may include a plurality of unit cells 122-1 to 122-N, which are stacked in the first direction. Here, “N” is a positive integer of 1 or greater, and may range from several tens to several hundreds. “N” may be determined depending on the intensity of the power to be supplied from the fuel cell 100A to a load. Here, “load” may refer to a part requiring power in a vehicle that uses the fuel cell.

Each unit cell 122-n may include a membrane electrode assembly (MEA) 210, gas diffusion layers (GDLs) 222 and 224, gaskets 232, 234, and 236, and separators (or bipolar plates) 242 and 244. Here, 1≤n≤N.

The membrane electrode assembly 210 has a structure in which catalyst electrode layers, in which electrochemical reactions occur, are attached to both sides of an electrolyte membrane through which hydrogen ions move. Specifically, the membrane electrode assembly 210 may include a polymer electrolyte membrane (or a proton exchange membrane) 212, a fuel electrode (a hydrogen electrode or an anode) 214, and an air electrode (an oxygen electrode or a cathode) 216. In addition, the membrane electrode assembly 210 may further include a sub-gasket 238.

The polymer electrolyte membrane 212 is disposed between the fuel electrode 214 and the air electrode 216.

Hydrogen, which is the fuel in the fuel cell 100A, may be supplied to the fuel electrode 214 through the first separator 242, and air containing oxygen as an oxidizer may be supplied to the air electrode 216 through the second separator 244.

The hydrogen supplied to the fuel electrode 214 is decomposed into hydrogen ions (protons) (H+) and electrons (e−) by the catalyst. The hydrogen ions alone may be selectively transferred to the air electrode 216 through the polymer electrolyte membrane 212, and at the same time, the electrons may be transferred to the air electrode 216 through the gas diffusion layers 222 and 224 and the separators 242 and 244, which are conductors. In order to realize the above operation, a catalyst layer may be applied to each of the fuel electrode 214 and the air electrode 216. The movement of the electrons described above causes the electrons to flow through an external conductive wire, thus generating current. That is, the fuel cell 100A may generate electric power due to the electrochemical reaction between hydrogen, which is the fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (hereinafter referred to as “condensed water” or “product water”). The condensed water generated in the air electrode 216 may penetrate the polymer electrolyte membrane 212 and may be transferred to the fuel electrode 214.

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The gas diffusion layers 222 and 224 serve to uniformly distribute hydrogen and oxygen, which are reactant gases, and to transfer the generated electrical energy. To this end, the gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 may serve to diffuse and uniformly distribute hydrogen supplied as a reactant gas through the first separator 242, and may be electrically conductive.

The second gas diffusion layer 224 may serve to diffuse and uniformly distribute air supplied as a reactant gas through the second separator 244, and may be electrically conductive.

Each of the first and second gas diffusion layers 222 and 224 may be a microporous layer in which fine carbon fibers are combined. However, the embodiments are not limited to any specific forms of the first and second gas diffusion layers 222 and 224.

The gaskets 232, 234, and 236 serve to maintain the airtightness and clamping pressure of the cell stack at an appropriate level with respect to the reactant gases and the coolant, to disperse the stress when the separators 242 and 244 are stacked, and to independently seal the flow paths.

The separators 242 and 244 may serve to move the reactant gases and the cooling medium and to separate each of the unit cells from the other unit cells. In addition, the separators 242 and 244 may serve to structurally support the membrane electrode assembly 210 and the gas diffusion layers 222 and 224 and to collect the generated current and transfer the collected current to the current collector 112.

The separators 242 and 244 may be respectively disposed outside the gas diffusion layers 222 and 224. That is, the first separator 242 may be disposed on the left side of the first gas diffusion layer 222, and the second separator 244 may be disposed on the right side of the second gas diffusion layer 224.

The first separator 242 serves to supply hydrogen as a reactant gas to the fuel electrode 214 through the first gas diffusion layer 222. To this end, the first separator 242 may include an anode plate (AP), in which a channel (i.e. a passage or a flow path) is formed so that hydrogen is capable of flowing therethrough.

The second separator 244 serves to supply air as a reactant gas to the air electrode 216 through the second gas diffusion layer 224. To this end, the second separator 244 may include a cathode plate (CP), in which a channel is formed so that air containing oxygen is capable of flowing therethrough. In addition, each of the first and second separators 242 and 244 may form a channel through which a cooling medium is capable of flowing.

Further, the separators 242 and 244 may be made of a graphite-based material, a composite graphite-based material, or a metal-based material. However, the embodiments are not limited to any specific material of the separators 242 and 244.

For example, each of the first and second separators 242 and 244 may include the first to third inflow communication portions IN1, IN2, and IN3 and the first to third outflow communication portions OUT1, OUT2, and OUT3, or may include some of the communication portions.

In other words, the reactant gases required for the membrane electrode assembly 210 may be introduced into the cell through the first and second inflow communication portions IN1 and IN2, and gas or liquid, in which the reactant gases humidified and supplied to the cell and the condensed water generated in the cell are combined, may be discharged to the outside of the fuel cell 100A through the first and second outflow communication portions OUT1 and OUT2.

The current collector 112 may be disposed between the cell stack 122 and each of the inner surfaces 110AI and 110BI of the first and second end plates 110A and 110B that face the cell stack 122.

The current collector 112 serves to collect electrical energy generated by the flow of electrons in the cell stack 122 and to supply the same to the load of the vehicle in which the fuel cell 100A is used. In an example, the current collector 112 may be implemented as a metal plate, which is made of an electrically conductive material, and may be conductively connected to the cell stack 122.

Each of the first and second end plates 110A and 110B described above may include a metal portion M having high rigidity in order to withstand the internal surface pressure of the cell stack 122 and to clamp the plurality of unit cells. For example, the metal portion M may be embodied by machining a metal material, such as aluminum or an aluminum composite material.

In addition, each of the end plates 110A and 110B is a part for clamping high-voltage parts, and thus needs to be insulative. Therefore, each of the end plates 110A and 110B may include a resin portion R, which is insulative and is disposed around each of the fluid inlet and the fluid outlet, which need to be insulated. The resin portion R may include an insulative material, for example a plastic material. In this case, the resin portion R may include a nylon-based material (PPA, PPS, PA66, or the like).

Each of the first and second end plates 110A and 110B may be formed such that the metal portion M is enveloped by the resin portion R.

Hereinafter, the end plates 110A and 110B, the enclosure 130A, and the outer gaskets 142 to 148 of the fuel cell 100A according to the embodiment will be described in detail.

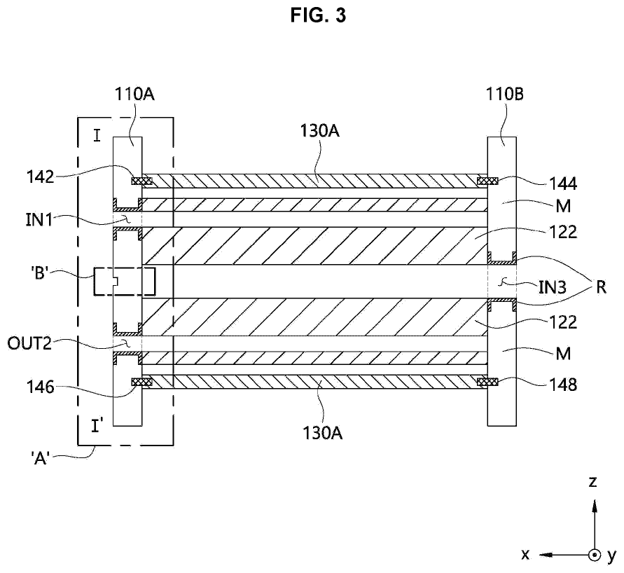

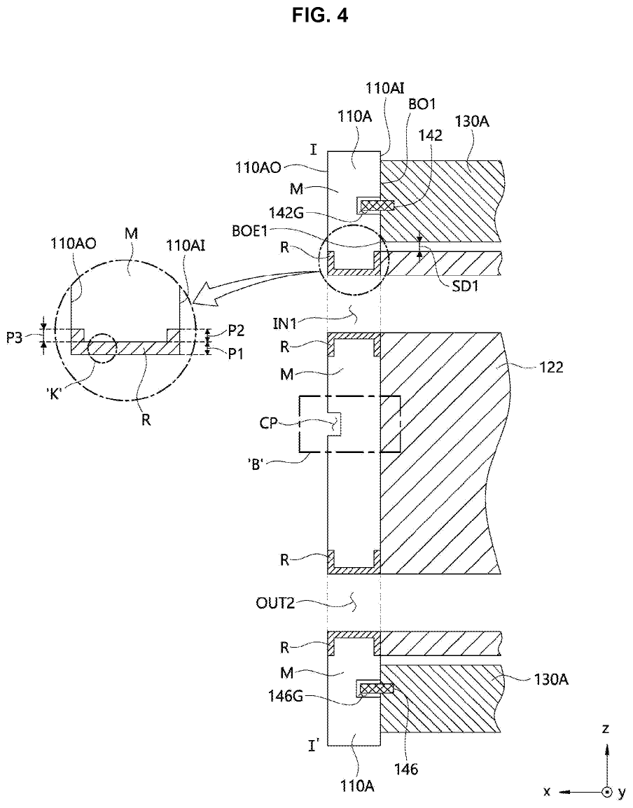

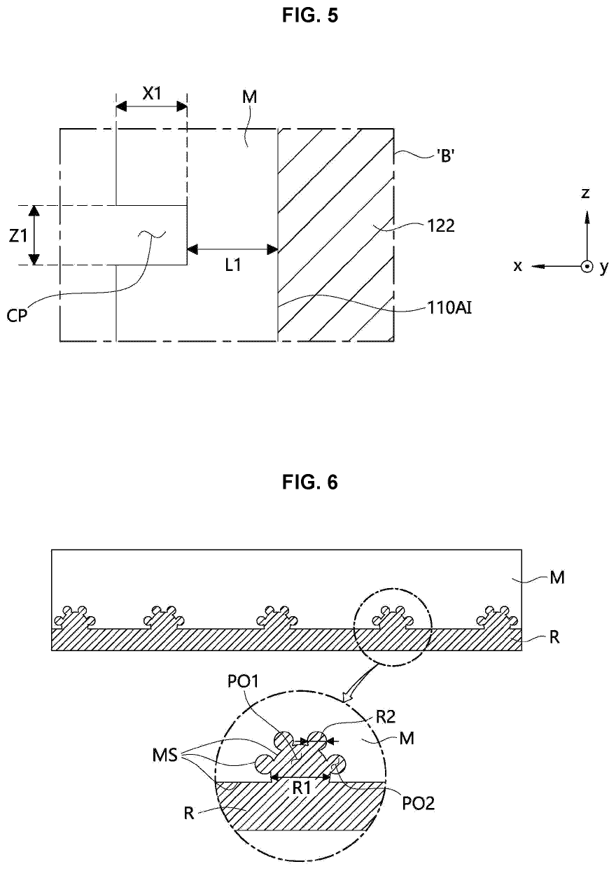

FIG. 3 is a cross-sectional view of the fuel cell 100A according to the embodiment, taken along line I-I′ shown in FIG. 1A, FIG. 4 is an enlarged cross-sectional view of portion A shown in FIG. 3, FIG. 5 is an enlarged cross-sectional view of portion B shown in FIG. 3, and FIG. 6 is an enlarged cross-sectional view of portion K shown in FIG. 4.

As described above, each of the end plates 110A and 110B may include the metal portion M and the resin portion R.

As shown in FIG. 6, the metal portion M may include a plurality of pores PO1 and PO2 formed in the surface MS thereof through molecular adhesion surface treatment. As illustrated, the sizes of the pores PO1 and PO2 may be different from each other. For example, the diameters R1 and R2 of the pores PO1 and PO2 may be about 0.1 μm to about 20 μm, but the embodiments are not limited thereto. That is, the diameter R1 of the first pore PO1 may be about 3 μm to about 20 μm, and the diameter R2 of the second pore PO2, which is smaller than the first pore PO1, may be about 0.1 μm to about 3 μm.

The resin portion R may be disposed on at least a portion of the surface MS of the metal portion M. Referring to FIG. 6, the resin portion R may be disposed on the surface MS of the metal portion M in the manner of being embedded in the pores PO1 and PO2.

The resin portion R may include a first portion P1, a second portion P2, and a third portion P3. The first portion P1 is a portion that is disposed in the flow path, i.e. each of the fluid inlets IN1, IN2, and IN3 and the fluid outlets OUT1, OUT2, and OUT3. The second portion P2 is a portion that is bent and extends from the first portion P1 to each of the inner surfaces 110AI and 110BI of the end plates 110A and 110B and is disposed around the flow path. The third portion P3 is a portion that is bent and extends from the first portion P1 to each of the outer surfaces 110AO and 110BO of the end plates 110A and 110B and is disposed around the flow path.

The inner surfaces 110AI and 110BI of the end plates 110A and 110B are surfaces facing the cell stack 122, and the outer surfaces 110AO and 110BO thereof are surfaces located opposite the inner surfaces 110AI and 110BI in the first direction.

For example, referring to FIG. 4, the resin portion R may include a first portion P1, which is disposed in the fluid inlet IN1, a second portion P2, which is bent and extends from the first portion P1 to the inner surface 110AI of the end plate 110A, and a third portion P3, which is bent and extends from the first portion P1 to the outer surface 110AO of the end plate 110A.

In addition, according to the embodiment, the second portion P2 of the resin portion R may be disposed so as to be spaced a predetermined distance SD1 apart from an end portion BOE1 of a boundary BO1 between each of the inner surfaces 110AI and 110BI of the end plates 110A and 110B and the enclosure 130A. For example, referring to FIG. 4, it can be seen that the second portion P2 extending from the first portion P1 disposed in the fluid inlet IN1 is spaced a predetermined distance SD1 apart from the end portion BOE1 of the boundary BO1 between the inner surface 110AI of the end plate 110A and the enclosure 130A.

That is, according to the embodiment, the resin portion R is not disposed on the boundary BO1 between the enclosure 130A and each of the end plates 110A and 110B.

In addition, the fuel cell 100A according to the embodiment may further include outer gaskets 142 to 148.

The outer gaskets 142 and 146 may be disposed between the enclosure 130A and the end plate 110A so as to contact the metal portion M of the end plate 110A, and the outer gaskets 144 and 148 may be disposed between the enclosure 130A and the end plate 110B so as to contact the metal portion M of the end plate 110B. The outer gaskets 142 to 148 may be received in respective gasket grooves formed in the end plates 110A and 110B. For example, the outer gaskets 142 and 146 shown in FIG. 4 may be respectively received in the gasket grooves 142G and 146G.

That is, according to the embodiment, none of the outer gaskets 142 to 148 is in contact with the resin portion R.

In addition, the end plates 110A and 110B may further include coupling grooves formed in the outer surfaces 110AO and 110BO thereof. For example, referring to FIGS. 4 and 5, the end plate 110A may include a coupling groove CP formed in the outer surface 110AO thereof. The coupling groove CP is used for engagement with peripheral auxiliary devices (balance-of-plant (BOP)) assisting in the operation of the fuel cell 100A. To this end, the coupling groove CP needs to be formed to a predetermined depth X1.

According to the embodiment, the coupling groove CP does not overlap the resin portion R in the first direction.

Further, the depth X1 of the coupling groove CP and the width (or the diameter) Z1 of the coupling groove CP may have the relationship shown in Equation 1 below, but the embodiments are not limited thereto.

X1=Z1×1.5±3 mm [Equation 1]

In this case, the thickness L1 of the remaining portion, excluding the coupling groove CP, may need to satisfy a minimum required value of 2 mm to 3 mm.

Hereinafter, a fuel cell 100B according to another embodiment will be described. The description of the fuel cell 100A also applies to the fuel cell 100B, which will be described below, except where otherwise described.

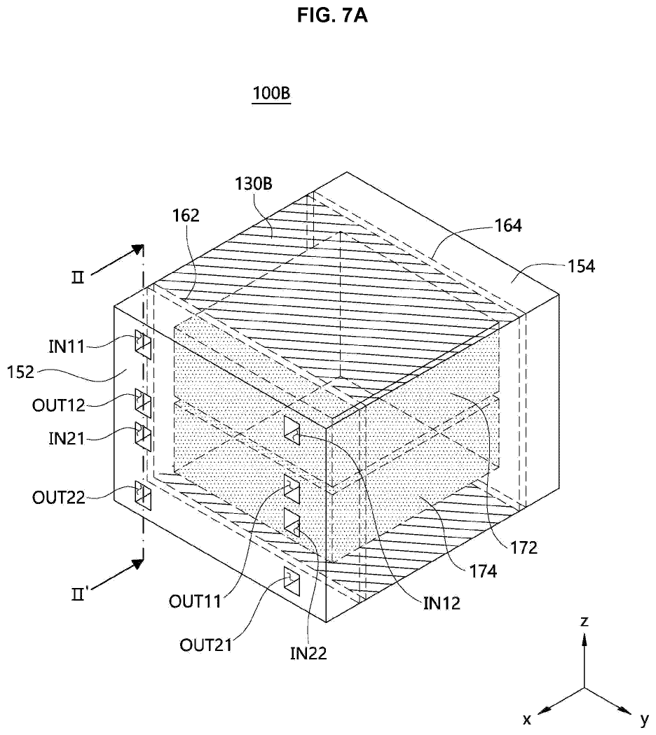

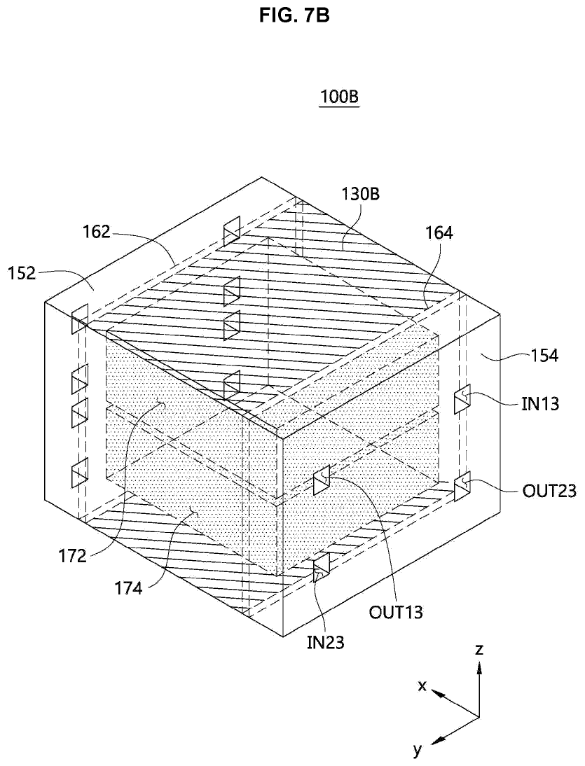

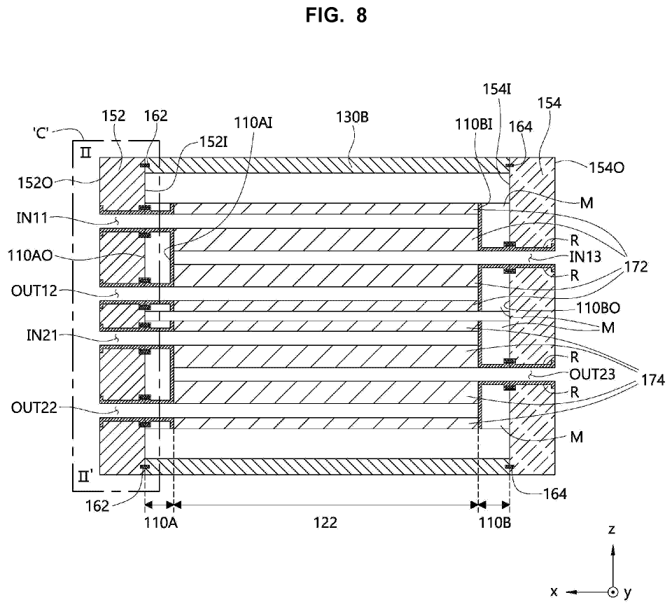

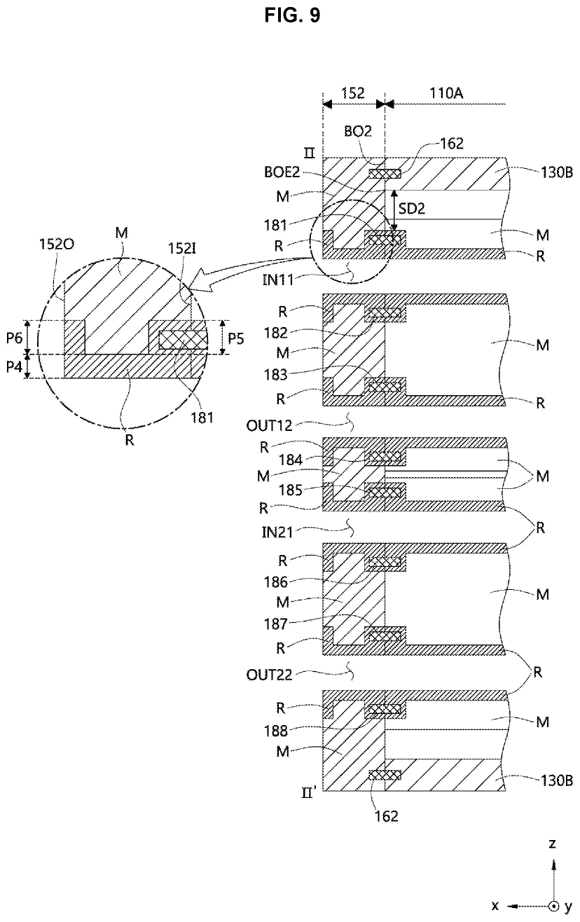

FIG. 7A is a front perspective view of the fuel cell 100B according to the another embodiment, FIG. 7B is a rear perspective view of the fuel cell 100B according to the another embodiment, FIG. 8 is a cross-sectional view of the fuel cell 100B according to the another embodiment, taken along line II-II′ shown in FIG. 7A, and FIG. 9 is an enlarged cross-sectional view of portion C shown in FIG. 8.

The fuel cell 100B according to the another embodiment may include a plurality of stack modules 172 and 174, an enclosure 130B, a manifold block 152, and a side cover 154.

The plurality of stack modules may be stacked on one another in at least one of the first direction, the second direction, or the third direction. In an example, as illustrated, the plurality of stack modules may include first and second stack modules 172 and 174, which are stacked in the third direction, but the embodiments are not limited to any specific stacking direction of the stack modules or any specific stacked number thereof.

Each of the plurality of stack modules 172 and 174 may have the same configuration as the fuel cell 100A shown in FIGS. 1A and 1B, excluding the enclosure 130A. That is, the fuel cell 100A shown in FIGS. 1A and 1B includes one stack module, whereas the fuel cell 100B shown in FIGS. 7A and 7B includes the plurality of stack modules 172 and 174.

Similar to what is illustrated in FIG. 2, each of the plurality of stack modules 172 and 174 may include a cell stack 122, end plates 110A and 110B, and a current collector 112. Therefore, the same parts are denoted by the same reference numerals, and redundant descriptions thereof will be omitted.

The parts denoted by reference numerals “110A” and “110B” in FIGS. 8 and 9 are parts corresponding to the first and second end plates 110A and 110B of each of the first and second stack modules 172 and 174, excluding the enclosure 130B.

The manifold block 152 may be disposed on one of the two ends of each of the plurality of stack modules 172 and 174, and the side cover 154 may be disposed on the other of the two ends of each of the plurality of stack modules 172 and 174.

The manifold block 152 may include a plurality of fluid inlets IN11, IN12, IN21, and IN22 and a plurality of fluid outlets OUT11, OUT12, OUT21, and OUT22, and the side cover 154 may include a plurality of fluid inlets IN13 and IN23 and a plurality of fluid outlets OUT13 and OUT23.

The plurality of fluid inlets IN11, IN12, and IN13 and the plurality of fluid outlets OUT11, OUT12, and OUT13 may be portions through which a fluid flows into and out of the upper stack module 172, and the plurality of fluid inlets IN21, IN22, and IN23 and the plurality of fluid outlets OUT21, OUT22, and OUT23 may be portions through which a fluid flows into and out of the lower stack module 174. That is, the fluid inlets IN11 and IN21, the fluid inlets IN12 and IN22, and the fluid inlets IN13 and IN23 respectively perform the same functions as the fluid inlets IN1, IN2, and IN3 shown in FIGS. 1A and 1B, and the fluid outlets OUT11 and OUT21, the fluid outlets OUT12 and OUT22, and the fluid outlets OUT13 and OUT23 respectively perform the same functions as the fluid outlets OUT1, OUT2, and OUT3 shown in FIGS. 1A and 1B. Therefore, duplicate descriptions thereof will be omitted.

That is, the manifold block 152 may serve to supply oxygen and hydrogen, which are reactant gases, to each of the first and second stack modules 172 and 174 and to discharge oxygen and hydrogen, which are reactant gases, and condensed water flowing out of each of the first and second stack modules 172 and 174. In addition, the side cover 154 may serve to supply coolant to each of the first and second stack modules 172 and 174 and to discharge the coolant flowing out of each of the first and second stack modules 172 and 174.

The enclosure 130B may be coupled to the manifold block 152 and to the side cover 154 to envelop the plurality of stack modules 172 and 174. Since the enclosure 130B is the same as the above-described enclosure 130A except for the difference in the components to which the enclosure is coupled, duplicate description thereof will be omitted.

In the fuel cell 100B according to the another embodiment, the manifold block 152 may include a metal portion M (hereinafter referred to as a “first metal portion”) and a resin portion R (hereinafter referred to as a “first resin portion”), the side cover 154 may also include a metal portion M (hereinafter referred to as a “second metal portion”) and a resin portion R (hereinafter referred to as a “second resin portion”), and each of the end plates 110A and 110B included in each of the stack modules 172 and 174 may also include a metal portion M (hereinafter referred to as a “third metal portion”) and a resin portion R (hereinafter referred to as a “third resin portion”).

The descriptions of the metal portion M and the resin portion R of each of the end plates 110A and 110B included in the fuel cell 100A according to the above embodiment may also apply to each of the first to third metal portions and each of the first to third resin portions. Therefore, duplicate descriptions of the same parts will be omitted.

In an example, as described above with reference to FIGS. 4 and 6, each of the first to third metal portions M may be provided with a plurality of pores PO1 and PO2 through molecular adhesion surface treatment, and each of the first to third resin portions R may be disposed on at least a portion of the surface of the metal portion M. Therefore, the descriptions of the metal portion M and the resin portion R made above with reference to FIGS. 4 and 6 may also apply to the first to third metal portions M and the first to third resin portions R shown in FIG. 9.

The first and third metal portions, the first and third resin portions, the outer gasket 162, and the inner gaskets 181 to 188, which are located on the left side C of the fuel cell 100B shown in FIG. 8, will be described with reference to FIG. 9. The descriptions thereof may also apply to the second and third metal portions, the second and third resin portions, the outer gasket 164, and the inner gasket, which are located on the right side of the fuel cell 100B.

In addition, the fuel cell 100B may further include first and second outer gaskets 162 and 164.

The first outer gasket 162 may be disposed between one end portion of the enclosure 130B and the manifold block 152, and the second outer gasket 164 may be disposed between the other end portion of the enclosure 130B and the side cover 154.

The first metal portion M of the manifold block 152 may be in contact with the first outer gasket 162, and the second metal portion M of the side cover 154 may be in contact with the second outer gasket 164.

That is, the first outer gasket 162 may not be in contact with the first resin portion R, and the second outer gasket 164 may not be in contact with the second resin portion R.

Each of the first to third resin portions R may include a fourth portion P4, a fifth portion P5, and a sixth portion P6. The fourth portion P4 is a portion that is disposed in the flow path, i.e. each of the fluid inlets IN11, IN12, IN13, IN21, IN22, and IN23 and the fluid outlets OUT11, OUT12, OUT13, OUT21, OUT22, and OUT23. The fifth portion P5 is a portion that is bent and extends from the fourth portion P4 to each of the inner surface 152I of the manifold block 152, the inner surface 154I of the side cover 154, and the inner surfaces 110AI and 110BI of the end plates 110A and 110B and is disposed around the flow path. The sixth portion P6 is a portion that is bent and extends from the fourth portion P4 to each of the outer surface 152O of the manifold block 152, the outer surface 154O of the side cover 154, and the outer surfaces 110AO and 110BO of the end plates 110A and 110B and is disposed around the flow path.

The inner surface 152I of the manifold block 152 and the inner surface 154I of the side cover 154 may be surfaces of the manifold block 152 and the side cover 154 that face the stack modules 172 and 174, and the outer surface 152O of the manifold block 152 and the outer surface 154O of the side cover 154 may be surfaces located opposite the inner surfaces 152I and 154I in the first direction.

For example, referring to FIG. 9, the first resin portion R may include a fourth portion P4, which is disposed in the fluid inlet IN11, a fifth portion P5, which is bent and extends from the fourth portion P4 to the inner surface 152I of the manifold block 152, and a sixth portion P6, which is bent and extends from the fourth portion P4 to the outer surface 152O of the manifold block 152.

In addition, according to the embodiment, the fifth portion P5 of each of the first and second resin portions R may be disposed so as to be spaced a predetermined distance apart from an end portion of a boundary between a corresponding one of the inner surfaces 152I and 154I and the enclosure 130B. For example, referring to FIG. 9, it can be seen that the fifth portion P5 extending from the fourth portion P4 disposed in the fluid inlet IN11 is spaced a predetermined distance SD2 apart from the end portion BOE2 of the boundary BO2 between the inner surface 152I of the manifold block 152 and the enclosure 130B.

That is, according to the embodiment, the first resin portion R may not be disposed on the boundary BO2 between the enclosure 130B and the manifold block 152, and the second resin portion R may not be disposed on the boundary between the enclosure 130B and the side cover 154.

In addition, as shown in FIGS. 8 and 9, the fuel cell 100B may further include inner gaskets. The inner gaskets 181 to 188 may be disposed between the manifold block 152 and the first end plate 110A of each of the stack modules 172 and 174. Similar thereto, the inner gaskets may also be disposed between the side cover 154 and the second end plate 110B of each of the stack modules 172 and 174.

In addition, each of the fuel cells 100A and 100B according to the embodiments described above may further include an anodizing layer 302.

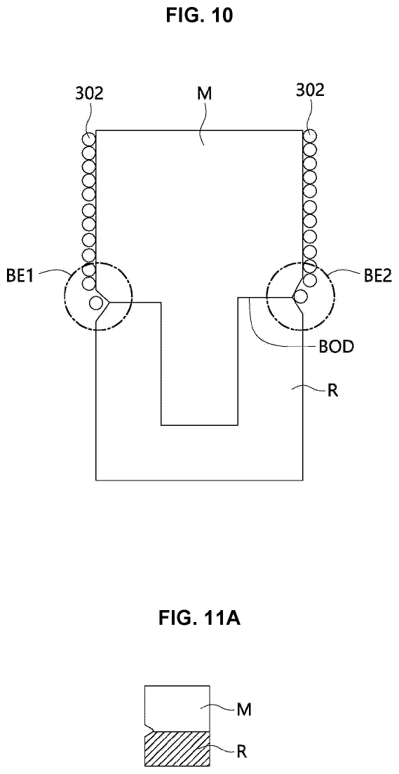

FIG. 10 is a partial cross-sectional view of each of the end plates 110A and 110B, the manifold block 152, and the side cover 154 in each of the fuel cells 100A and 100B according to the embodiments described above.

The metal portion M and the resin portion R shown in FIG. 10 may correspond to the metal portion M and the resin portion R of each of the end plates 110A and 110B of the fuel cell 100A according to the embodiment, or may correspond to any one of the first to third metal portions M and any one of the first to third resin portions R.

As shown in FIG. 10, the anodizing layer 302 may be formed on the surface of the metal portion M. In addition, according to the embodiment, the anodizing layer 302 may be disposed so as to cover end portions BE1 and BE2 of a boundary BOD between the metal portion M and the resin portion R.

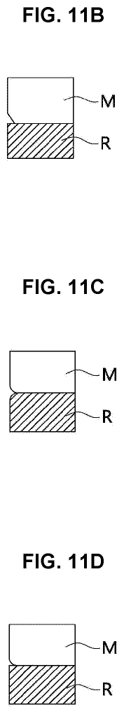

FIGS. 11A to 11D show various embodiments of the metal portion M and the resin portion R shown in FIG. 10.

According to the embodiments, at least one of the metal portion M or the resin portion R may have a sectional shape that is chamfered or filleted at the end portions BE1 and BE2 of the boundary BOD.

For example, as shown in FIG. 11A, both the metal portion M and the resin portion R may have sectional shapes that are chamfered at each of the end portions BE1 and BE2 of the boundary BOD. As shown in FIG. 11B, only the metal portion M may have a sectional shape that is chamfered at each of the end portions BE1 and BE2 of the boundary BOD. As shown in FIG. 11C, both the metal portion M and the resin portion R may have sectional shapes that are filleted at each of the end portions BE1 and BE2 of the boundary BOD. As shown in FIG. 11D, only the metal portion M may have a sectional shape that is filleted at each of the end portions BE1 and BE2 of the boundary BOD.

Further, the metal portion M and the resin portion R may have sectional shapes that are symmetrical with each other in the second direction at each of the end portions BE1 and BE2 of the boundary BOD. Here, the second direction may be a direction that intersects the first direction and in which the metal portion M and the resin portion R face each other. For example, as shown in FIGS. 11A and 11C, the metal portion M and the resin portion R may have sectional shapes that are symmetrical with each other in the second direction at each of the end portions BE1 and BE2 of the boundary BOD.

Hereinafter, a method 400 of manufacturing the fuel cell according to the above-described embodiment will be described with emphasis on the metal portion M and the resin portion R with reference to the accompanying drawings.

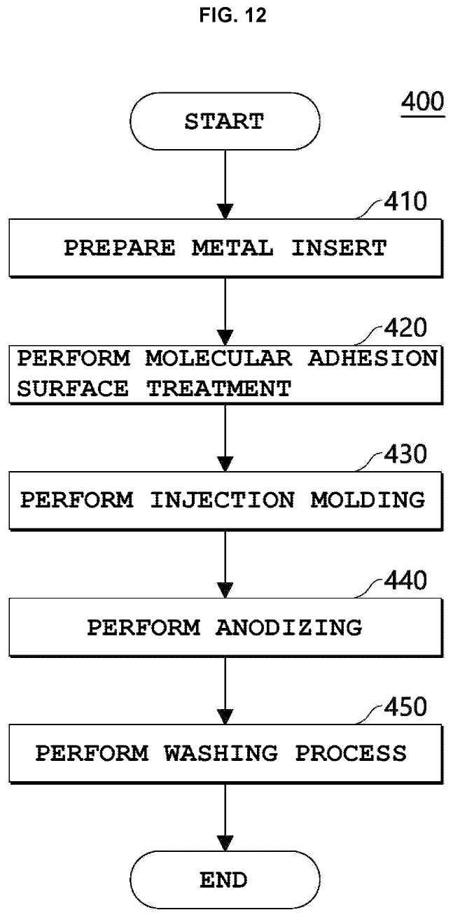

FIG. 12 is a flowchart for explaining the method 400 of manufacturing the fuel cells 100A and 100B according to the embodiments.

The end plates 110A and 110B of the fuel cell 100A according to the previous embodiment and the manifold block 152, the side cover 154, and the end plates 110A and 110B included in each of the plurality of stack modules 172 and 174 of the fuel cell 100B according to the another embodiment may be manufactured by performing steps 410 to 450 shown in FIG. 12.

First, a metal insert is prepared (step 410). The metal insert may be manufactured in a desired shape through sand casting, low-pressure casting, counter-pressure casting, die casting, extrusion, or the like.

After step 410, molecular adhesion surface treatment may be performed on the metal insert (step 420).

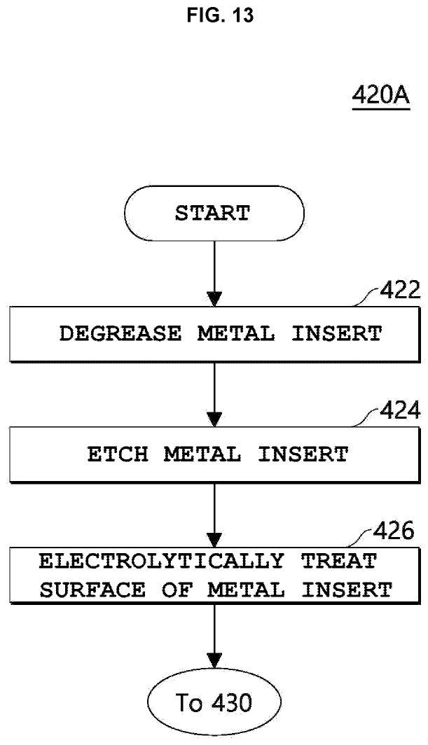

FIG. 13 is a flowchart for explaining an exemplary embodiment 420A of step 420 shown in FIG. 12.

First, the metal insert may be degreased before being etched (step 422). That is, foreign substances remaining on the metal insert, such as grease, may be removed.

After step 422, the metal insert may be etched using an etchant to form the pores PO1 and PO2 in the surface MS of the metal insert M, as shown in FIG. 6 (step 424).

In step 424, the first pores PO1 may be formed in the surface of the metal insert using a first etchant. Thereafter, the second pores PO2, which are smaller than the first pores PO1, may be formed in the surface of the metal insert using a second etchant.

That is, after the first pores PO1 having uniform sizes are formed using the first etchant, the second pores PO2, which are finer than the first pores PO1, may be formed in the metal insert, having the first pores PO1 formed therein, using the second etchant.

For example, the first etchant may include distilled water and at least one of oxalic acid, acetic acid, nitric acid, hydrochloric acid, or hydrogen peroxide, and the second etchant may include sodium bicarbonate, sodium hydroxide, sodium tetraborate, and di stilled water.

For example, the etching temperature in step 424 may be 40° C. to 60° C., and each of the primary etching process using the first etchant and the secondary etching process using the second etchant may be performed for 1 to 2 minutes.

After step 424, the surface of the metal insert may be electrolytically treated using an electrolyte to complete the manufacture of the metal portion M (step 426). In this case, the electrolyte may include distilled water and a compound containing oxalic acid, sulfuric acid, or carboxylic acid.

Referring again to FIG. 12, after step 420, injection molding may be performed to form the resin portion R on the surface of the metal portion M that has undergone molecular adhesion surface treatment (step 430).

After step 430, post-treatment for corrosion resistance may be performed (steps 440 and 450).

That is, after step 430, as shown in FIG. 10, anodizing may be performed to form the anodizing layer 302 on the surface of the metal portion M and each of the end portions BE1 and BE2 of the boundary between the metal portion M and the resin portion R (step 440).

After step 440, the product that has undergone anodizing may be washed (step 450). When step 440 is performed, the anodizing solution may adhere to the plastic surface of the resin portion R. Therefore, post-treatment such as washing may be required in step 450.

After step 450, a stacking process may be performed.

When the fuel cells 100A and 100B are manufactured through the method 400 described above, the adhesion strength between the metal portion M and the resin portion R of each of the end plates 110A and 110B of the fuel cell 100A, the manifold block 152 of the fuel cell 100B, the side cover 154 of the fuel cell 100B, and the end plates 110A and 110B included in each of the plurality of stack modules 172 and 174 of the fuel cell 100B may be increased. For example, as the adhesion strength, tensile strength may be about 300 MPa or greater and shear strength may be about 16 MPa or greater. However, the embodiments are not limited thereto.

Hereinafter, a comparative example and the fuel cell according to the embodiment will be described with reference to the accompanying drawings.

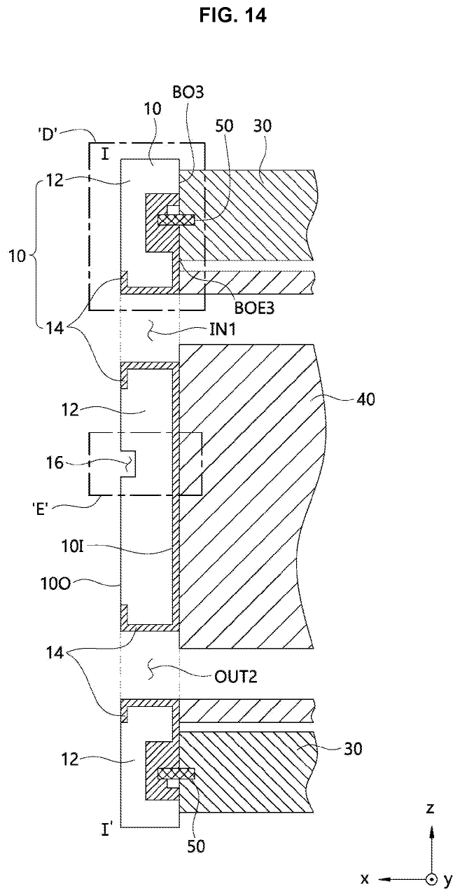

FIG. 14 is a partial cross-sectional view of a fuel cell according to a comparative example.

The fuel cell according to the comparative example shown in FIG. 14 may include an end plate 10, an enclosure 30, a cell stack 40, and an outer gasket 50. The fuel cell according to the comparative example shown in FIG. 14 may be compared with the fuel cell 100A according to the embodiment shown in FIG. 4. That is, the end plate 10, the enclosure 30, the cell stack 40, and the outer gasket 50 shown in FIG. 14 may respectively perform the same functions as the end plate 110A, the enclosure 130A, the cell stack 122, and the outer gasket 142 shown in FIG. 4, and thus duplicate descriptions thereof will be omitted.

Similar to the end plate 110A according to the embodiment, the end plate 10 according to the comparative example may include a metal portion 12 and a resin portion 14.

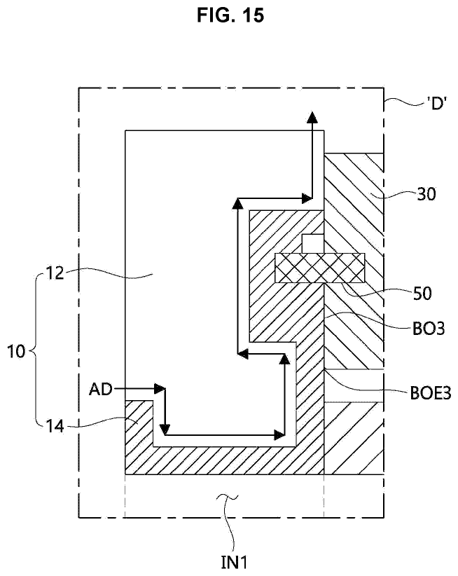

FIG. 15 is an enlarged cross-sectional view of portion D shown in FIG. 14.

Referring to FIG. 15, in the case of the fuel cell according to the comparative example, a resin portion 14 may extend to a position at which the outer gasket 50 is disposed, rather than being spaced a predetermined distance apart from an end portion BOE3 of a boundary BO3 between the enclosure 30 and the end plate 10. The reason for this is to prevent deterioration in the watertightness or airtightness of the fuel cell due to the entry of external moisture and flow thereof in the direction of the arrow AD. That is, in the comparative example, the outer gasket 50 is in contact with the resin portion 14, rather than being in contact with the metal portion 12 of the end plate 10.

In contrast, according to the embodiment, before an injection molding process is performed on the metal insert placed in an injection mold, a fine undercut structure may be formed through molecular adhesion surface treatment. That is, the pores PO1 and PO2 are formed in the metal insert. Accordingly, plastic permeates the fine pores, whereby the metal portion M and the resin portion R are strongly bonded to each other. As a result, the adhesion strength between the metal portion M and the resin portion R is greater than that in the comparative example.

That is, in the fuel cell 100A according to the embodiment, the metal portion M of each of the end plates 110A and 110B may be subjected to molecular adhesion surface treatment to form the pores PO1 and PO2 therein, and then the resin portion R may be embedded in the pores PO1 and PO2. Therefore, the adhesion strength between the metal portion M and the resin portion R is greater than that in the comparative example, thereby preventing the entry of moisture in the direction of the arrow AD shown in FIG. 15, thus improving watertightness performance. Accordingly, as shown in FIG. 4, the resin portion R (e.g. P2) is capable of being disposed so as to be spaced a predetermined distance SD1 apart from the end portion BOE1 of the boundary BO1. That is, in the embodiment, the outer gasket 142 is in contact with the metal portion M of each of the end plates 110A and 110B, rather than being in contact with the resin portion R thereof.

In addition, in the fuel cell 100B according to the another embodiment, the metal portion M of the manifold block 152, the side cover 154, or each of the end plates 110A and 110B included in each of the stack modules 172 and 174 may be subjected to molecular adhesion surface treatment to form the pores PO1 and PO2 therein, and then the resin portion R is embedded in the pores PO1 and PO2. Therefore, the adhesion strength between the metal portion M and the resin portion R is greater than that in the comparative example, thereby preventing the entry of external moisture through the end portion BOE2 of the boundary BO2 between the metal portion M and the resin portion R, thus improving watertightness performance. Accordingly, as shown in FIG. 9, the resin portion R (e.g. P5) is capable of being disposed so as to be spaced a predetermined distance SD2 apart from the end portion BOE2 of the boundary BO2. That is, in the embodiment, the outer gaskets 162 and 164 are in contact with the metal portions M of the manifold block 152 and the side cover 154, rather than being in contact with the resin portions R thereof.

When the area occupied by the resin portion R is reduced for the above reasons, the resin portion R may be easily manufactured in desired dimensions. That is, the dimensional stability of the resin portion R may be improved.

In addition, since it is possible to prevent the occurrence of a lifting or sinking phenomenon due to thermal contraction caused by a fall in the temperature of the plastic after an injection molding process, the resin portion R may be easily manufactured in desired dimensions. That is, the dimensional stability of the resin portion R may be improved. Furthermore, the manufacturing yield of the product may be increased, the manufacturing costs thereof may be lowered, and the quality thereof may be improved.

In addition, according to the embodiment, since it is possible to prevent the occurrence of a peeling, contraction, or lifting phenomenon due to the difference in thermal contraction between the resin portion R and the metal portion M, the dimensional quality thereof may be improved. Accordingly, the end plates 110A and 110B have increased flatness, and thus function to uniformly distribute the surface pressure of the cell stack 122.

In addition, even when thermal shock or fatigue shock is applied to the fuel cells 100A and 100B according to the embodiments at the time of startup or stoppage of the cell stack 122 or due to the climate, it may be possible to prevent cracking caused by the difference in the coefficient of thermal expansion between the metal portion M and the resin portion R by virtue of the structure in which the resin portion R is embedded in the fine pores PO1 and PO2.

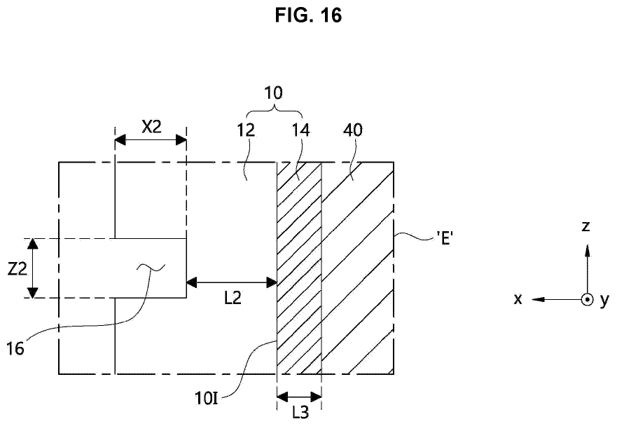

FIG. 16 is an enlarged cross-sectional view of portion E shown in FIG. 14.

Since a coupling groove 16 formed in the outer surface 100 of the end plate 10 shown in FIG. 16 may perform the same function as the coupling groove CP shown in FIG. 4, duplicate description thereof will be omitted.

The resin portion 14 may be disposed on the inner surface 101 of the end plate 10 shown in FIG. 16, whereas the resin portion R may not be disposed on the inner surface 110AI of the first end plate 110A shown in FIG. 5.

In this case, even if the depth X2 and the width Z2 of the coupling groove 16 and the thickness L2 of the remaining portion, excluding the coupling groove 16, shown in FIG. 16 are equal to “X1”, “Z1”, and “L1” shown in FIG. 5, respectively, the thickness of the end plate in the first direction in the fuel cell according to the embodiment may be reduced by the thickness L3 of the resin portion 14 shown in FIG. 16 compared to the fuel cell according to the comparative example.

The thickness L3 may be set to 2 mm or greater in order to ensure watertightness. Therefore, according to the embodiment, there is a spatial margin for securing a minimum mounting depth required for the end plates 110A and 110B. Accordingly, when the fuel cell is packaged, the size of the package may be reduced.

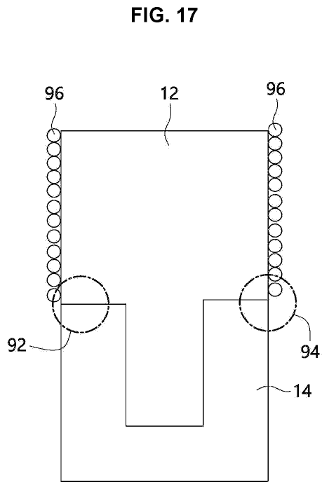

FIG. 17 is a partial cross-sectional view of the fuel cell according to the comparative example.

The fuel cell according to the comparative example shown in FIG. 17 may further include an anodizing layer 96 disposed on the metal portion 12. In this case, however, an anodizing solution does not permeate the end portions 92 and 94 of the boundary between the metal portion 12 and the resin portion 14, and thus the anodizing layer 96 is not formed on the end portions 92 and 94. Thus, white rust may be generated on the end portions 92 and 94.

In contrast, according to the embodiment, as illustrated in FIGS. 11A to 11D, at least one of the metal portion M or the resin portion R may be chamfered or filleted at the end portions BE1 and BE2 so that an anodizing solution is capable of permeating the end portions BE1 and BE2, and thus the anodizing layer 302 may be generated on the end portions BE1 and BE2, as shown in FIG. 10, thereby preventing the generation of white rust.

As is apparent from the above description, according to the fuel cell and the manufacturing method thereof according to the embodiments, watertightness may be improved, cracking caused by the difference in the coefficient of thermal expansion between the metal portion and the resin portion may be prevented, and dimensional stability may be improved. In addition, the manufacturing yield of the product may be increased, the manufacturing costs thereof may be lowered, and the quality thereof may be improved. Furthermore, the thickness of the cell stack in the stacking direction may be reduced, and the surface pressure of the cell stack may be uniformly distributed.

However, the effects achievable through the disclosure may not be limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell comprising:
a cell stack comprising a plurality of unit cells stacked in a first direction;
an end plate disposed on each of two ends of the cell stack, the end plate comprising i) a metal portion subjected to molecular adhesion surface treatment and ii) a resin portion disposed on at least a portion of a surface of the metal portion; and
an enclosure coupled to the end plate to envelop the cell stack; and
an outer gasket disposed between the enclosure and the end plate in a state of being in contact with the metal portion of the end plate.

2. The fuel cell according to claim 1, wherein the end plate comprises:
an inner surface facing the cell stack;
an outer surface located opposite the inner surface in the first direction;
a fluid inlet receiving a fluid to be supplied to the cell stack; and
a fluid outlet discharging a fluid flowing out of the cell stack, and
wherein the resin portion comprises:
a first portion disposed in each of the fluid inlet and the fluid outlet;
a second portion extending from the first portion to the inner surface; and
a third portion extending from the first portion to the outer surface.

3. The fuel cell according to claim 2, wherein the second portion of the resin portion is disposed so as to be spaced apart from a boundary between the inner surface of the end plate and the enclosure.

4. The fuel cell according to claim 1, wherein the metal portion comprises a plurality of pores formed in a surface thereof, and
wherein the resin portion is disposed on the surface of the metal portion while being embedded in the pores.

5. The fuel cell according to claim 4, wherein the plurality of pores has respectively different sizes.

6. The fuel cell according to claim 5, wherein each of the plurality of pores has a diameter of about 0.1 μm to about 20 μm.

7. The fuel cell according to claim 2, wherein the end plate further comprises a coupling groove formed in the outer surface thereof, and
wherein the coupling groove does not overlap the resin portion in the first direction.

8. The fuel cell according to claim 1, further comprising:
an anodizing layer formed on a surface of the metal portion,
wherein the anodizing layer is disposed so as to cover an end portion of a boundary between the metal portion and the resin portion.

9. The fuel cell according to claim 8, wherein at least one of the metal portion or the resin portion has a sectional shape chamfered or filleted at the end portion of the boundary.

10. The fuel cell according to claim 9, wherein the metal portion and the resin portion have sectional shapes symmetrical with each other in a second direction at the end portion of the boundary,
wherein the second direction intersects the first direction, and
wherein the metal portion and the resin portion face each other in the second direction.

11. The fuel cell according to claim 1, wherein, for adhesion strength between the metal portion and the resin portion, tensile strength is about 300 MPa or greater and shear strength is about 16 MPa or greater.

12. A method of manufacturing a fuel cell, the method comprising:
preparing a metal insert;
performing molecular adhesion surface treatment on the metal insert; and
forming a resin on a metal portion, subjected to the molecular adhesion surface treatment, through injection molding to manufacture a resin portion.

13. The method according to claim 12, wherein the performing molecular adhesion surface treatment comprises etching the metal insert using an etchant to form a pore in a surface of the metal insert.

14. The method according to claim 13, wherein the performing molecular adhesion surface treatment further comprises:
degreasing the metal insert before the etching; and
electrolytically treating the surface of the metal insert using an electrolyte after the etching to complete manufacture of the metal portion.

15. The method according to claim 13, wherein the etching comprises:
forming a first pore in the surface of the metal insert using a first etchant; and
forming a second pore in the surface of the metal insert using a second etchant, the second pore being smaller than the first pore.

16. The method according to claim 12, further comprising:
anodizing the metal portion after performing the injection molding; and
washing a product obtained by the anodizing.

17. A fuel cell, comprising:
a plurality of stack modules;
a manifold block disposed on one of two ends of each of the plurality of stack modules;
a side cover disposed on a remaining one of the two ends of each of the plurality of stack modules;
an enclosure coupled to the manifold block and the side cover to envelop the plurality of stack modules;
a first outer gasket disposed between one end portion of the enclosure and the manifold block; and
a second outer gasket disposed between a remaining end portion of the enclosure and the side cover,
wherein the manifold block comprises a first metal portion subjected to molecular adhesion surface treatment and a first resin portion disposed on at least a portion of a surface of the first metal portion,
wherein the side cover comprises a second metal portion subjected to molecular adhesion surface treatment and a second resin portion disposed on at least a portion of a surface of the second metal portion,
wherein the first metal portion of the manifold block is in contact with the first outer gasket, and
wherein the second metal portion of the side cover is in contact with the second outer gasket.

18. The fuel cell according to claim 17, wherein each of the manifold block and the side cover comprises:
an inner surface facing the plurality of stack modules;
an outer surface located opposite the inner surface in a first direction;
a fluid inlet receiving a fluid to be supplied to the plurality of stack modules; and
a fluid outlet discharging a fluid flowing out of the plurality of stack modules, and
wherein each of the first resin portion and the second resin portion comprises:
a fourth portion disposed in each of the fluid inlet and the fluid outlet;
a fifth portion extending from the fourth portion to the inner surface; and
a sixth portion extending from the fourth portion to the outer surface.

19. The fuel cell according to claim 18, wherein the fifth portion is disposed so as to be spaced apart from a boundary between the inner surface and the enclosure.
